(19) United States
(12) Patent Application Publication
(10) Pub. No.: US 2002/0059730 A1
(43) Pub. Date: May 23, 2002

(54) Folding knife with a locking catch

(76) Inventor: Jean-Pierre Flavigny, Saint Pe Sur Nivelle (FR)

Correspondence Address: WENDEROTH, LIND & PONACK, L.L.P., 2033 K STREET N. W., SUITE 800, WASHINGTON, DC, 20006-1021, US

(21) Appl. No.: 09/989,430

(22) Filed: Nov. 21, 2001

(30) Foreign Application Priority Data
Nov. 23, 2000 (FR) 00 15 146

(51) Int. Cl. B26B 1/04

(52) U.S. Cl. 30/161

(57) ABSTRACT

This knife comprises a handle (7), at least one blade (3) mounted so that it can pivot on the said handle (7) between a position in which it is retracted into the handle (7) and an open work position, and a member (31, 41) for locking the blade (3) in the open position. In the open position, the blade makes an angle with respect to the main direction of the handle that is appreciably greater than 10° and appreciably smaller than 90°, preferably between 20° and 60°, and preferably roughly equal to 40°.

Application to a two-bladed electrician's knife for cutting and stripping electric cables.

The present invention relates to a folding knife having a handle which is elongate in a main direction, at least one blade mounted so that it can pivot on the said handle between a position in which it is at least partially retracted into the handle and an open work position, and a member for locking the blade in the open position.

Many knives of this kind are known in the state of the art under the general term of “flick knife”.

They are often relatively complicated to manufacture given the various members needed to perform the aforementioned functions. The complexity of the design is further exacerbated in the case of two-bladed folding knives, such as electricians' knives, in which one blade is designed to cut through a cable and the other blade is designed to be used for cable-stripping operations.

A main object of the invention is to produce a folding knife of the type described above, and in which the open position is stable and defined positively to guarantee longitudinal and circular cuts in complete safety.

To this end, in the open position, the blade makes an angle with respect to the main direction of the handle appreciably greater than 10° and appreciably smaller than 90°, and preferably 40°.

According to other features:

the blade has a length of between 30 mm and 55 mm and in particular roughly equal to 45 mm;

the blade has a concave cutting edge, the mean radius of curvature of which is between 40 mm and 60 mm, particularly roughly equal to 50 mm;

the knife has two pivoting blades of different lengths, the first blade having a length greater than the length of the second blade, each of the blades making a respective acute angle with respect to the main direction of the handle, the angle associated with the second blade being greater than the angle associated with the first blade, appreciably greater than 10° and appreciably smaller than 90°, and preferably between 20° and 60°, and preferably roughly equal to 40°; and

the knife has two pivoting blades of different lengths, each having a concave cutting edge with a respective curvature which is different for each blade, and each making a respective acute angle with respect to the main direction of the handle, one of the blades being associated both with the larger of the two angles and the larger of the two curvatures.

Another main object of the invention is to produce a folding knife of the aforementioned type, further comprising a member for actuating the said locking member to switch the said member from a locking position to an unlocked position, and a member for returning the locking member to the locking position, which is less expensive to manufacture and extremely reliable.

To this end, the actuating member and the return member are formed on a single operating piece mounted on the handle.

According to other features:

the said operating piece is a lever mounted so that it can pivot on the handle about a pin that is transverse with respect to the main direction;

the blade has a notch and the locking member has a projection that complements the said notch, formed on the lever;

the blade has an edge forming a cam near the notch, the said cam collaborating with the projection between the retracted position and the open position of the blade;

the lever is partially retracted into the handle, and the actuating member projects from the handle on the opposite side of the lever from the locking projection with respect to the pivot pin of the lever;

the lever has three branches arranged roughly in a Y-configuration in a longitudinal plane of the handle, and its pivot pin lies roughly at the region where the three branches meet, two of the three branches supporting, respectively, the locking member and the actuating member, while the other branch constitutes the return member;

the handle is secured to at least one transverse relief and the branch constituting the return member has a free end part which bears on the said relief so that pressure exerted on the actuating member causes elastic deformation of the said branch and generates an elastic return force on the lever, returning it towards a position of rest of the said lever;

when the lever is in the position of rest, either the blade is in its open position and the projection is engaged in the notch, or the blade is in the retracted position in the handle and the projection rests against the cam, creating a force on the blade that opposes the opening thereof;

the cam and the projection are configured in such a way that the elastic action of the lever on the blade tends to bring the blade into one or other of its positions: open and retracted;

the knife has two blades each associated with an operating piece, and which pivot with respect to the handle about a common pivot pin; and

the two blades are associated with a common operating piece formed between them in the handle.

An exemplary embodiment of the invention will now be described with reference to the appended drawings, in which:

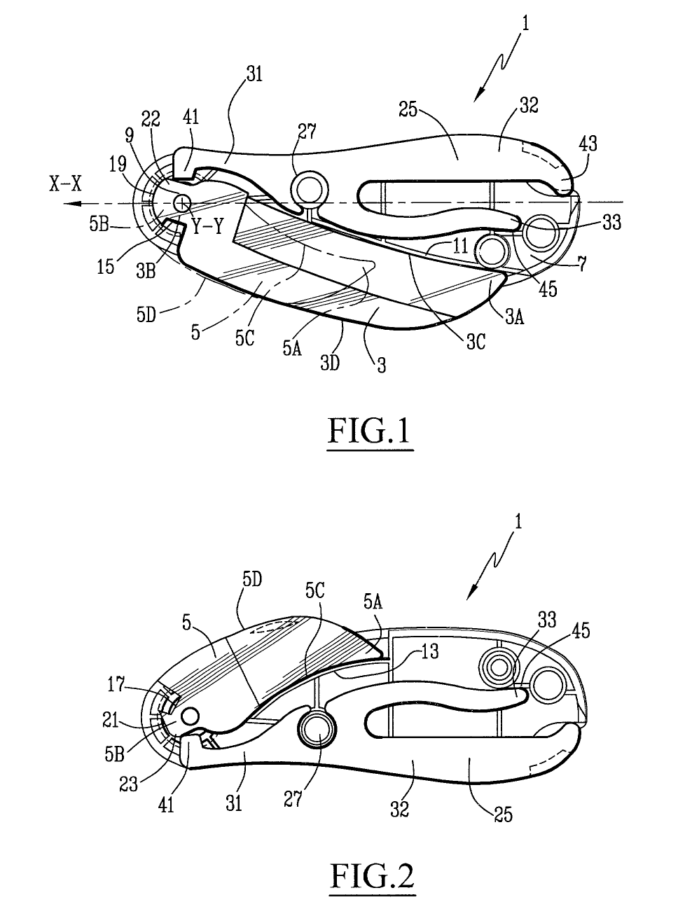

FIG. 1 is a view in a longitudinal plane, passing through the handle and containing the first blade, of a two-bladed knife according to the invention, the blades being folded;

FIG. 2 is a view in the parallel plane containing the second blade, imagining that the knife shown in FIG. 1 has been turned through 180° about the longitudinal axis that embodies the main direction of the handle;

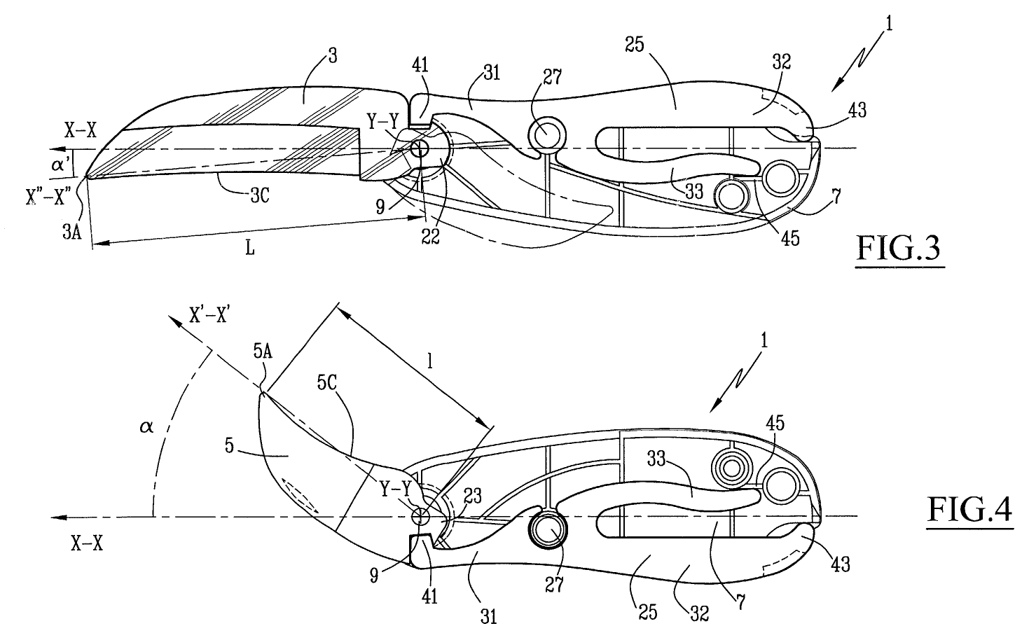

FIG. 3 is a view similar to FIG. 1, the first blade being folded out;

FIG. 4 is a view similar to FIG. 2, the second blade being folded out;

FIG. 5 is a view similar to FIG. 1, illustrating the opening of the first blade to its folded-out position;

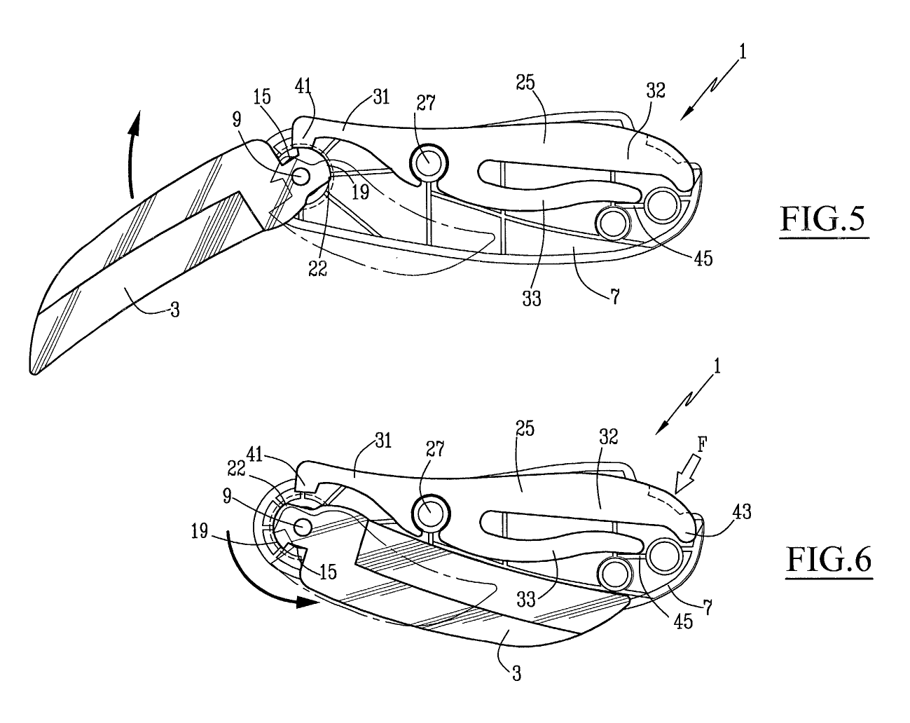

FIG. 6 is a view similar to FIG. 5, illustrating the movement of the first blade from its folded-out position to its folded position;

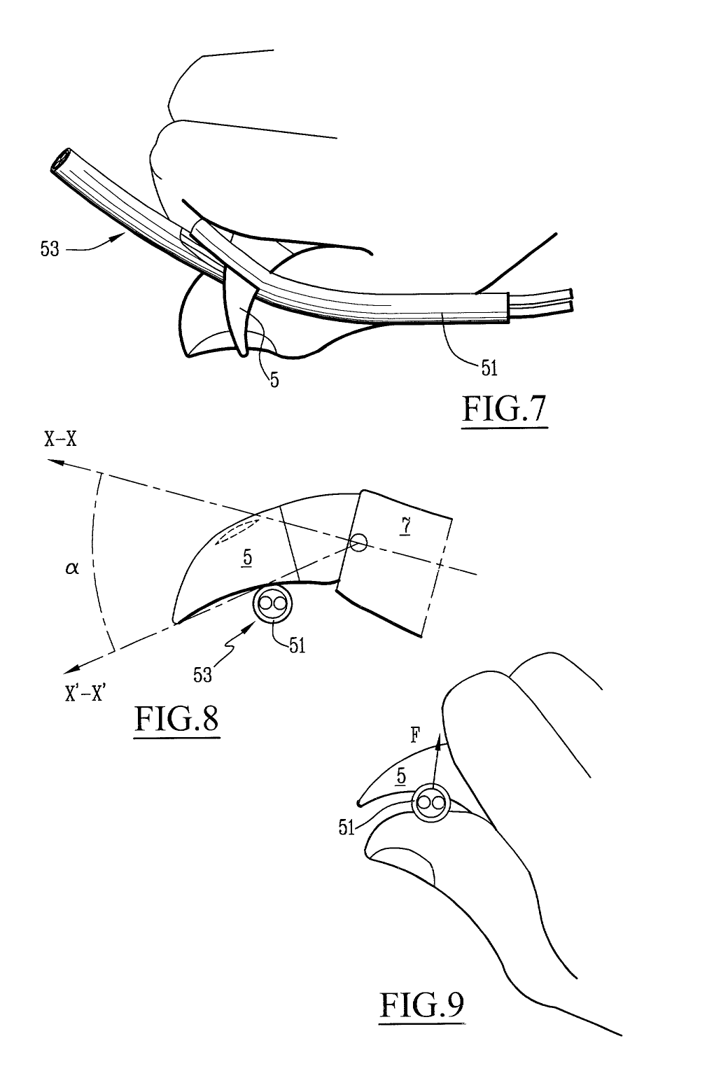

FIG. 7 is a schematic view showing the use of the second blade for longitudinally cutting through the insulating sheath of an electric cable; and

FIGS. 8 and 9 are similar views depicting circular cutting of the sheath of the cable.

FIG. 1 depicts a knife 1 with two folding blades 3, 5, the first 3 of which is a long blade and the second 5 of which is a short blade. The knife 1 has a handle 7 which is elongate in a main direction X-X and slit by two parallel slots intended to house the blades 3 and 5, respectively. In FIG. 1, the knife is viewed in the plane of the slot that accommodates the long blade 3.

The two blades 3, 5 are mounted so that they can pivot on the handle 7 about a common axis Y-Y embodied by a journal 9.

The main direction X X of the handle 7 is defined more specifically with respect to this axis Y-Y of pivoting as being the axis which, in the plane of a blade 3, 5 connects the axis of pivoting Y-Y and the proximal end of the handle 7.

Each blade 3, 5 has a pointed respective free end 3A, 5A and an opposite end 3B, 5B for articulation about the journal 9.

Each blade 3, 5 is mounted so that it can pivot with respect to the handle 7 about the axis Y-Y, so as to be movable between a position in which it is folded or partially retracted into the corresponding slot of the handle 7, and a folded-out or open work position, as depicted in FIGS. 3 and 4. In its work position, the blade 3 runs more or less in the continuation of the handle 7.

With reference to FIGS. 1 and 2, each blade 3, 5 has a concave respective cutting edge 3C, 5C and an outside edge 5D. When the blade is in the retracted position, the cutting edge 3C, 5C rests against a rib 11, 13 of complementary shape formed in the handle at the bottom of the slot, the ribs 11, 13 constituting a rotational end stop for the respective blade 3, 5.

Each blade 3, 5 has a respective notch 15, 17 formed in the articulation end part 3B, 5B on the outside edge 3D, 5D side. The edge of the blade 3, 5 delimiting the articulation end 3B, 5B and connecting the notch 15, 17 to the cutting edge 3C, 5C constitutes a cam 19, 21. Each cam 19, 21 has a respective angular point 22, 23 in an intermediate part.

The knife 1 has an operating piece 25 consisting of a lever mounted so that it can rotate on the handle 7 about a cylindrical stud 27 extending from the handle 7 into both of the slots that accommodate the blades 3, 5. The stud 27 is formed in an intermediate region of the handle 7, along its longitudinal axis X-X corresponding to the main direction.

The lever 25 is a Y-shaped piece the three branches 31, 32, 33 of which extend into each of the slots that accommodate the blades 3, 5.

The operating piece 25 described in this particular embodiment of the invention is a single operating piece associated with both blades 3, 5, but it is possible as an alternative to provide two separate operating pieces 25, each respectively associated with one of the blades 3, 5 and capable of pivoting independently with respect to the handle 7.

The operating piece, or lever, 25 is formed as one piece.

The branch 31 constitutes a member for locking the blades 3, 5 in their open work position, the branch 32 constitutes an actuating member protruding from the handle 7 so as to be operable by the user, and the branch 33 constitutes a member for elastically returning the lever 35 to its position of rest.

The branch 31 corresponding to the locking member has, at its free end, adjacent to the articulation end 3B, 5B of the blades 3, 5, a projection 41 facing towards the articulation journal 9 and complementing the notches 15 to 17, so as to able to immobilize one or other of the blades in the open position (this position has been depicted in FIGS. 3 and 4).

The branch 32 corresponding to the actuating member runs more or less in the continuation of the branch 31 so that, when the lever 25 is in the position of rest, it coincides with an outside edge of the handle 7. Only a free end part 43 forming an operating button, at the opposite end to the projection 41 and to the journal 9, protrudes appreciably from the overall bulk of the handle 7, the handle having a recess in this region.

The branch 33 corresponding to the elastic return member extends, when the blades 3, 5 are in the retracted position in the handle 7, between the branch 32 corresponding to the actuating member and the blades 3, 5. The free end of the branch 33 corresponding to the elastic return member rests on a rib 45 of the handle 7 forming a stop, the said rib 45 opposing the clockwise pivoting of the return branch 33, and at the same time the other two branches 31, 32, about the stud 27.

Reference is now made to FIGS. 3 and 4 which respectively depict the knife in the positions in which the long blade 3 and the short blade 5 are in the open work positions.

Here we define the main direction of a blade 3, 5 by the axis which, in the plane of the blade, connects its axis of pivoting Y-Y and its tip 3A, 5A, namely its distal end.

The length L, l of a blade 3, 5 is also defined as the distance from its tip 3A, 5A to the axis of pivoting Y-Y.

The length l of the short blade 5 is advantageously chosen to be between 30 mm and 55 mm, particularly roughly equal to 45 mm according to the preferred embodiment which has been depicted.

It is more clearly apparent from these figures that the mean curvature of the concave cutting edge 5C of the short blade 5 is greater than the mean curvature of the concave cutting edge 3C of the long blade 3. Advantageously, the mean radius of curvature of the short blade 5 is between 40 mm and 60 mm, particularly roughly equal to 50 mm.

Furthermore, in the open position, the long blade 3 has a main direction X″,-X″, which makes an angle α′ smaller than 10° with the longitudinal axis X-X of the handle 7, whereas the acute angle a formed between the main direction X-X of the handle 7 and the main direction X′-X′ of the short blade 5 is appreciably greater than 10° and smaller than 90°, preferably between 20° and 60°, and more preferably still roughly equal to 40°.

The type of knife thus designed is particularly suited to use by electricians, the long blade 3 being particularly well-suited to cutting through electric cables and the short blade 5 being particularly suited to stripping them.

In the positions depicted in FIGS. 1 to 4, the lever 25 is in its rest position, that is to say that the return branch 33 is hardly or not stressed in bending on the rib 45. It will therefore be appreciated that the open position of one of the blades 3, 5 (or both blades, but this does not correspond to normal use) corresponds to the position of rest of the lever 25. The same is true of the retracted position of one or both blades 3, 5.

With reference now to FIGS. 5 and 6, the movement of the long blade 3 from one of its extreme positions to the other, that is to say the open work position and the retracted position in the handle 7, will be described. Operation regarding the other blade 5 is exactly the same, and it therefore seems unnecessary to illustrate it.

As can be seen in FIG. 5, which corresponds to a phase of opening the blade 3 out of the handle 7, the projections 41 bears against the cam 21 during the phase of angular excursion of the blade 3 about the journal 9, so that the lever 25 pivots about the stud 27 and the return branch 33 is elastically deformed by butting against the rib 45. It will be appreciated that the lever 25, via the projection 41 exerts, between the retracted position and the open position of the blade 3, a return force on said blade 3 so as to cause it to tend towards one or other of its extreme positions.

It will be understood more specifically that the cam 19 is configured so that the lever 25 exerts a return force returning the blade 3 towards its open position when the projection 41 bears against that part of the cam 19 that lies between the notch 15 and the angular point 22, whereas it exerts a force returning the blade 3 towards its retracted position when the projection 41 bears against the part of the cam 19 that lies on the other side of the angular point 22. The angular point 22 defines a “hard point” corresponding to a peak of effort that the user has to furnish in order to open the blade 3.

At the end of the excursion of the blade 3, which corresponds to the travel of the projection 41 along the cam 19, the projection 41 drops into the notch 15, the lever 25 then returning to its rest position (the position depicted in FIG. 3). It will be readily understood that in the open position, the blades 3 and 5 are in the locked position, and are therefore very stable for making longitudinal and circular cuts.

FIG. 6 illustrates the movement of the blade 3 from its open position to its retracted position, and the action needed on the part of the user in order to perform this operation. As indicated by the arrow F, the user has to exert pressure on the button 43 against the elastic return force of the return branch 33 of the lever 25 so as to disengage the projection 41 from the notch 15 and be able to return the blade 3 to its retracted position in the handle 7, through a movement of angular excursion of the blade in the anticlockwise direction.

FIG. 7 illustrates one mode of use of the short blade 5, which consists in cutting tangentially through the insulating sheath 51 of an electric cable 53, in the longitudinal direction of the cable.

FIGS. 8 and 9 depict an operation of making a circular radial cut through an insulating sheath 51 of an electric cable 53 prior to pulling off in the longitudinal direction the section of sheath thus cut.

It is evident from these figures that when making longitudinal tangential and circular radial cuts in an electric cable of circular cross section, for example, the inclination, the exterior shape and the curvature of the cutting edge of the short blade 5 encourage the cable to be held centrally between the cutting edge and the thumb of the user. In the case of a circular cut, the inclination and curvature of the cutting edge of the blade 5 guarantee that the cable is held centrally with respect to the force F of the thumb, which makes it possible, as the knife is rotated about the cable, to remain in the circular cutting groove. This thus avoids any helical cutting.

As can be seen, the invention makes it possible to produce a folding knife, particularly an electrician's two-bladed knife, which has a short blade particularly suited to the work of peeling and stripping electric cables, and which, in its open position, is inclined at 45° and in a stable manner with respect to the axis of the handle and which also has an operating piece provided with the locking, operating and elastic return functions, this piece being of simple design and easy to manufacture. For example, this piece is made of metal so that it maintains good elastic properties over time and is able to withstand a great many operating cycles.

1. Folding knife, particularly an electrician's folding knife, having a handle (7) which is elongate in a main direction (X-X), at least one blade (3, 5) mounted so that it can pivot on the said handle (7) between a position in which it is at least partially retracted into the handle (7) and an open work position, and a member (31, 41) for locking the blade (3, 5) in the open position, characterized in that the blade (5) is between 30 mm and 55 mm long, has a concave cutting edge (5C) and, in the open position, makes an acute angle (α) with respect to the main direction (X-X) of the handle (7) that is appreciably greater than 10° and appreciably smaller than 90°, preferably between 20° and 60°, and preferably roughly equal to 40°.

2. Folding knife according to claim 1, characterized in that the length of the blade (5) is roughly equal to 45 mm.

3. Folding knife according to claim 1, characterized in that the mean radius of curvature of the blade (5) is between 40 mm and 60 mm, particularly roughly equal to 50 mm.

4. Folding knife according to claim 1, characterized in that it has two pivoting blades (3, 5) of different lengths (L, l), the first blade (3) having a length (L) greater than the length (l) of the second blade (5), each of the blades (3, 5) making a respective acute angle ((α′, α) with respect to the main direction (X-X) of the handle (7), the angle (α) associated with the second blade (5) being greater than the angle (α′) associated with the first blade (3), appreciably greater than 10° and appreciably smaller than 90°, and preferably between 20° and 60°, and preferably roughly equal to 40°.

5. Folding knife according to claim 1, characterized in that it has two pivoting blades (3, 5) of different lengths (L, l), each having a concave cutting edge (3C, 5C) with a respective curvature which is different for each blade, and each making a respective acute angle (α′, α) with respect to the main direction (X-X) of the handle (7), one (5) of the blades (3, 5) being associated both with the larger (α) of the two angles (α, α′) and the larger of the two curvatures.

6. Folding knife according to claim 1, further comprising a member (32, 43) for actuating the said locking member (31, 41) to switch the said member from a locking position to an unlocked position, and a member (33) for returning the locking member (31, 41) to the locked position, characterized in that the actuating member (32, 43) and the return member (33) are formed on a single operating piece (25) mounted on the handle (7).

7. Folding knife according to claim 6, characterized in that the said operating piece (25) is a lever mounted so that it can pivot on the handle (7) about a pin (27) that is transverse with respect to the main direction (X-X).

8. Folding knife according to claim 7, characterized in that the blade (3, 5) has a notch (15, 17) and the locking member (31, 41) has a projection (41) that complements the said notch (15, 17), formed on the lever (25).

9. Folding knife according to claim 8, characterized in that the blade (3, 5) has an edge forming a cam (19, 21) near the notch (15, 17), the said cam (19, 21) collaborating with the projection (41) between the retracted position and the open position of the blade (3, 5).

10. Folding knife according to claim 8, characterized in that the lever (25) is partially retracted into the handle (7), and the actuating member (32, 43) projects from the handle (7) on the opposite side of the lever (25) from the locking projection (41) with respect to the pivot pin (27) of the lever (25).

11. Folding knife according to claim 7, characterized in that the lever (25) has three branches (31, 32, 33) arranged roughly in a Y-configuration in a longitudinal plane of the handle (7), and its pivot pin (27) lies roughly at the region where the three branches meet, two of the three branches (31, 32, 33) supporting, respectively, the locking member (31, 41) and the actuating member (32, 43), while the other branch (32) constitutes the return member.

12. Folding knife according to claim 11, characterized in that the handle (7) is secured to at least one transverse relief (45) and the branch (33) constituting the return member has a free end part which bears on the said relief (45) so that pressure exerted on the actuating member (32, 43) causes elastic deformation of the said branch (33) and generates an elastic return force on the lever (25), returning it towards a position of rest of the said lever (25).

13. Folding knife according to claims 5 and 8 taken together, characterized in that, when the lever (25) is in the position of rest, either the blade (3, 5) is in its open position and the projection (41) is engaged in the notch (15, 17), or the blade (3, 5) is in the retracted position in the handle (7) and the projection (41) rests against the cam (19, 21), creating a force on the blade (3, 5) that opposes the opening thereof.

14. Folding knife according to claim 13, characterized in that the cam (19, 21) and the projection (41) are configured in such a way that the elastic action of the lever (25) on the blade (3, 5) tends to bring the blade (3, 5) into one or other of its positions: open and retracted.

15. Folding knife according to claim 6, characterized in that it has two blades (3, 5) each associated with an operating piece (25), and which pivot with respect to the handle (7) about a common pivot pin (27).

16. Folding knife according to claim 15, characterized in that the two blades (3, 5) are associated with a common operating piece (25) formed between them in the handle (7).
